(19) United States
(12) Patent Application Publication
(10) Pub. No.: US 2026/0008127 A1
(43) Pub. Date: Jan. 8, 2026

(54) LASER ANNEALING SYSTEM AND LASER ANNEALING METHOD

(71) Applicants: Gigaphoton Inc., Oyama-shi (JP); KYUSHU UNIVERSITY, NATIONAL UNIVERSITY CORPORATION, Fukuoka-shi (JP)

(72) Inventors: Yohei TANAKA, Oyama-shi (JP); Hisato YABUTA, Fukuoka-shi (JP); Keita KATAYAMA, Fukuoka-shi (JP)

(73) Assignees: Gigaphoton Inc., Oyama-shi (JP); KYUSHU UNIVERSITY, NATIONAL UNIVERSITY CORPORATION, Fukuoka-shi (JP)

(21) Appl. No.: 19/232,689

(22) Filed: Jun. 9, 2025

(30) Foreign Application Priority Data
Jul. 8, 2024 (JP) 2024-109910

(51) Int. Cl. B23K 26/354

(52) U.S. Cl. CPC B23K 26/354

(57) ABSTRACT

A laser annealing system for annealing a thin film on a substrate by irradiating the thin film with a pulse laser beam includes a laser apparatus configured to output the pulse laser beam, an optical system configured to irradiate the thin film with the pulse laser beam, and a processor configured to perform control of irradiating the same section of the thin film with the pulse laser beam by performing burst irradiation that alternates between a burst period of continuously performing irradiation with the pulse laser beam and a suppression period of suppressing the continuous irradiation with the pulse laser beam.

### CROSS-REFERENCE TO RELATED APPLICATIONS

The present application claims the benefit of Japanese Patent Application No. 2024-109910, filed on Jul. 8, 2024, the entire contents of which are hereby incorporated by reference.

### BACKGROUND

### 1. Technical Field

The present disclosure relates to a laser annealing system and a laser annealing method.

### 2. Related Art

Indium tin oxide (ITO) is used for a flat panel display including a glass substrate, a solar cell, and a transparent electrode film. When heat treatment (annealing) is applied to the ITO, the ITO is crystallized from an amorphous state, and electrical conductivity and carrier mobility as an electrode are improved.

The transparent electrode film is also expected to be applied to an optical integrated element that realizes a device with higher functionality. The optical integrated element is realized by forming an active element such as a sensor, an amplifier circuit, or a complementary metal oxide semiconductor (CMOS) circuit on an uppermost layer of an integrated circuit device. Therefore, there is a demand for a technology of producing a transparent electrode film with higher quality.

With the diversification of information terminal devices, there is an increasing demand for a flexible display, a flexible computer, and a flexible solar cell that are small in size, are light in weight, consume less power, and can be freely bent. For this reason, there is a need to establish a technology for forming a high-quality transparent electrode film on a plastic substrate of polyethylene terephthalate (PET) and the like.

In order to form a high-quality transparent electrode thin film on a glass substrate, an integrated circuit, or a plastic substrate, it is necessary to crystallize the transparent electrode film without causing thermal damage to those substrates. The process temperature is 400° C. for a glass substrate used in a display, whereas a process temperature of 150° C. or lower is required for PET used in a plastic substrate or an integrated circuit.

In the alloying of a metal film used for a magnetic sensor element or the like, a metal material thin film is formed on a magnetic shield substrate, and annealing is performed as well. The magnetic shield substrate also has a material with poor heat resistance, and hence it is necessary to heat only a surface layer to be alloyed in an upper layer.

In addition to transparent electrodes and magnetic sensor elements, annealing is used to reduce the resistivity of electrode wiring of a large scale integrated circuit (LSI) and to recover crystals and to diffuse dopants in a semiconductor process. There may be steps in which the influence of heat is desired to be avoided depending on the materials and structures of underlying layers.

A laser annealing method is used as a technology of annealing only a surface layer without causing thermal damage to a base substrate. In this method, a pulsed ultraviolet laser beam to be absorbed by a semiconductor thin film in an upper layer is used in order to suppress damage to a substrate due to thermal diffusion.

When the semiconductor thin film is silicon, a XeF excimer laser having a wavelength of 351 nm, a XeCl excimer laser having a wavelength of 308 nm, a KrF excimer laser having a wavelength of 248 nm, or the like is used. Those gas lasers in the ultraviolet region have a characteristic in which the coherence of the laser beam is lower than that of a solid-state laser, the energy uniformity on a laser beam irradiation surface is excellent, and a wide region can be uniformly annealed with a high pulse energy.

### LIST OF DOCUMENTS

### Patent Documents

Patent Document 1: Japanese Unexamined Patent Application Publication No. 2020-202242
Patent Document 2: US 2022/0072663 A1

### SUMMARY

A laser annealing system according to one aspect of the present disclosure may be configured to anneal a thin film on a substrate by irradiating the thin film with a pulse laser beam. The laser annealing system may include a laser apparatus, an optical system, and a processor. The laser apparatus may be configured to output the pulse laser beam. The optical system may be configured to irradiate the thin film with the pulse laser beam. The processor may be configured to perform control of irradiating the same section of the thin film with the pulse laser beam by performing burst irradiation that alternates between a burst period of continuously performing irradiation with the pulse laser beam and a suppression period of suppressing the irradiation with the pulse laser beam.

A laser annealing method according to another aspect of the present disclosure may be a laser annealing method of annealing a thin film on a substrate by irradiating the thin film with a pulse laser beam. The laser annealing method may include outputting the pulse laser beam from a laser apparatus, irradiating the thin film with the pulse laser beam by an optical system, and irradiating the same section of the thin film with the pulse laser beam by performing burst irradiation that alternates between a burst period of continuously performing irradiation with the pulse laser beam and a suppression period of suppressing the irradiation with the pulse laser beam.

### BRIEF DESCRIPTION OF THE DRAWINGS

Embodiments of the present disclosure will be described below merely as examples with reference to the accompanying drawings.

FIG. 1 is a graph showing an example of a burst operation of a laser apparatus.

FIG. 2 schematically shows a configuration of an exemplary laser annealing system.

FIG. 3 is a graph showing the pulse energy of a pulse laser beam with which an ITO thin film is irradiated in laser annealing treatment according to Comparative Example 1 and the change in temperature (thin film surface temperature) in the vicinity of a front surface of the ITO thin film in accordance with the laser irradiation.

FIG. 4 is a graph showing an example of the pulse energy of a pulse laser beam with which an ITO thin film is irradiated in laser annealing treatment according to Comparative Example 2, the change in the thin film surface temperature in accordance with the laser irradiation, and the change in temperature near the interface between the ITO film and a substrate (interface temperature).

FIG. 5 is a graph showing an example of burst irradiation performed by a laser annealing system according to Embodiment 1 and an example of the changes in the thin film surface temperature and the interface temperature in accordance with the burst irradiation.

FIG. 6 is a graph showing an example of burst irradiation performed by a laser annealing system according to Modification 1 of Embodiment 1 and an example of the changes in the thin film surface temperature and the interface temperature in accordance with the burst irradiation.

FIG. 7 schematically shows a configuration of a laser annealing system according to Modification 2 of Embodiment 1.

FIG. 8 is an enlarged side view of a cooling plate and an object to be irradiated shown in FIG. 7.

FIG. 9 is a timing chart showing control examples of a cooling operation.

FIG. 10 is a graph showing the change in the thin film surface temperature in accordance with continuous irradiation with a pulse laser beam.

FIG. 11 is an explanatory diagram schematically showing a process of crystallization of a thin film in accordance with continuous irradiation with the pulse laser beam shown in FIG. 10.

FIG. 12 is a graph showing an example of a burst pattern and an example of the change in the thin film surface temperature in accordance with burst irradiation.

FIG. 13 is an explanatory diagram schematically showing a process of crystallization of a thin film in accordance with burst irradiation shown in FIG. 12.

FIG. 14 schematically shows crystal grains produced by the burst irradiation shown in FIG. 12.

FIG. 15 is a graph showing an example of burst irradiation of a laser annealing system according to Embodiment 2 and an example of the change in the thin film surface temperature in accordance with the burst irradiation.

FIG. 16 is an explanatory diagram schematically showing a process of crystallization of the thin film by the burst irradiation shown in FIG. 15.

FIG. 17 shows an example of burst irradiation according to Modification 1 of Embodiment 2 and an example of the change in the thin film surface temperature in accordance with the burst irradiation.

FIG. 18 shows an example of burst irradiation according to Modification 2 of Embodiment 2 and an example of the change in the thin film surface temperature in accordance with the burst irradiation.

FIG. 19 schematically shows a configuration of a laser annealing system according to Embodiment 3.

FIG. 20 is a perspective view showing an example of a roll-to-roll conveyance mechanism applied to the laser annealing system.

FIG. 21 is an explanatory diagram showing a configuration and an operation of a laser annealing system according to Modification 1 of Embodiment 3.

FIG. 22 schematically shows a configuration of a laser annealing system according to Modification 2 of Embodiment 3.

FIG. 23 schematically shows a configuration of a laser annealing system according to Embodiment 4.

FIG. 24 is a graph showing an example of burst irradiation implemented by the laser annealing system.

### DESCRIPTION OF EMBODIMENTS

### Contents

1. Terminology
2. Example of Laser Annealing System
2.1 Configuration
2.2 Operation
3. Problem 1
4. Embodiment 1
4.1 Configuration
4.2 Operation
4.3 Effect
4.4 Modification 1 of Embodiment 1
4.4.1 Configuration
4.4.2 Operation
4.4.3 Effect
4.5 Modification 2 of Embodiment 1
4.5.1 Configuration
4.5.2 Operation
4.5.3 Effect
5. Problem 2
6. Embodiment 2
6.1 Configuration
6.2 Operation
6.3 Effect
6.4 Modification 1 of Embodiment 2
6.5 Modification 2 of Embodiment 2
6.6 Other
7. Embodiment 3
7.1 Configuration
7.2 Operation
7.3 Example of Conveyance Mechanism
7.4 Effect
7.5 Modification 1 of Embodiment 3
7.5.1 Configuration
7.5.2 Operation
7.5.3 Effect
7.6 Modification 2 of Embodiment 3
7.6.1 Configuration
7.6.2 Operation
7.6.3 Effect
8. Embodiment 4
8.1 Configuration
8.2 Operation
8.3 Effect
9. Applications Other than ITO Thin Film
10. Processor
11. Other

Hereinafter, embodiments of the present disclosure will be described in detail with reference to the drawings. The embodiments described below show some examples of the present disclosure and do not limit the contents of the present disclosure. Not all configurations and operations described in the embodiments are necessarily essential as configurations and operations of the present disclosure. Here, the same components are denoted by the same reference numerals, and overlapping descriptions thereof are omitted.

### 1. Terminology

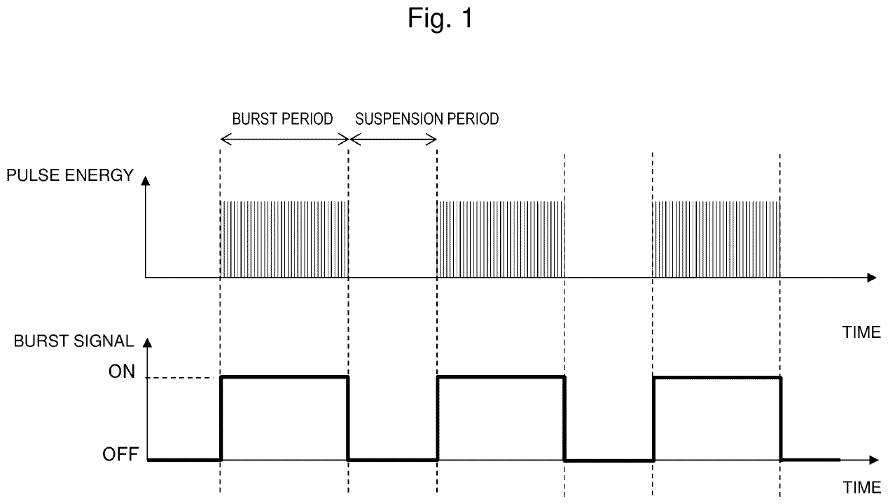

FIG. 1 is a graph showing an example of a burst operation of a laser apparatus. The laser apparatus may output a pulse laser beam by the burst operation. The burst operation is an operation of alternating a burst period in which a pulse laser beam is continuously output at a constant repetition frequency for a certain period of time and a suspension period in which a pulse laser beam is not output for a predetermined period of time. During the burst period, a pulse laser beam is output from the laser apparatus. During the suspension period, the output of the pulse laser beam is stopped.

A burst pattern that is a repetitive pattern of a burst period and a suspension period is defined by data including any one or more of the pulse energy of the burst period, the repetition frequency, the number of pulses and the length of the suspension period, and the number of bursts. The burst pattern is specified by an external apparatus such as an exposure machine or a processing machine.

The burst signal is ON during a burst period and OFF during a suspension period and specifies a burst operation.

### 2. Example of Laser Annealing System

### 2.1 Configuration

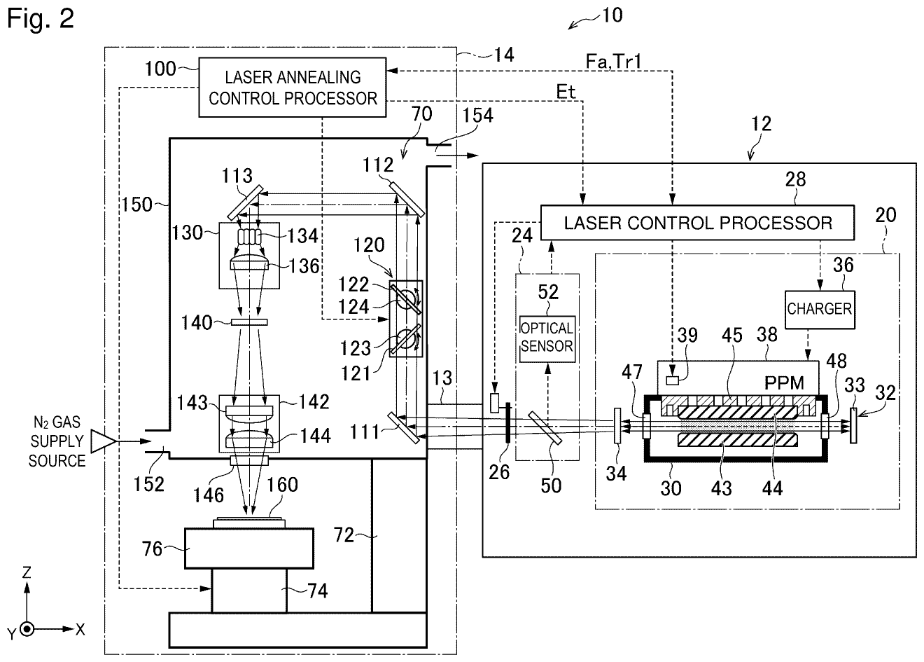

FIG. 2 schematically shows a configuration of an exemplary laser annealing system 10. The laser annealing system 10 includes a laser apparatus 12, an optical path tube 13, and a laser annealing apparatus 14.

The laser apparatus 12 outputs a pulse laser beam of ultraviolet light. For example, the laser apparatus 12 may be a discharge-pumped laser apparatus using F2, ArF, KrF, XeCl or XeF as a laser medium. Alternatively, the laser apparatus 12 may be a solid-state laser apparatus that outputs an ultraviolet wavelength.

The laser apparatus 12 includes an oscillator 20, a monitor module 24, a shutter 26, and a laser control processor 28.

The oscillator 20 includes a chamber 30, an optical resonator 32, a charger 36, and a pulse power module (PPM) 38.

Excimer laser gas is enclosed in the chamber 30. The chamber 30 includes a pair of electrodes 43, 44, an insulating member 45, and windows 47, 48.

The optical resonator 32 includes a rear mirror 33 and an output coupler (OC) 34. The rear mirror 33 and the OC 34 are obtained by coating planar substrates with a high reflective film and a partial reflective film, respectively. The chamber 30 is disposed on an optical path of the optical resonator 32.

The PPM 38 includes a switch 39 and a charge capacitor (not shown). The switch 39 is connected to a signal line for transmitting a control signal from the laser control processor 28.

The charger 36 is connected to the charge capacitor of the PPM 38. The charger 36 receives data on charging voltage from the laser control processor 28 and charges the charge capacitor of the PPM 38.

The monitor module 24 includes a beam splitter 50 and an optical sensor 52.

The shutter 26 is disposed on the optical path of the pulse laser beam output from the monitor module 24. The optical path of the pulse laser beam may be sealed by a housing (not shown) and the optical path tube 13 and be purged with inert gas such as N₂ gas.

The optical path tube 13 is a cover that covers the optical path of the pulse laser beam between an exit port of the pulse laser beam of the laser apparatus 12 and an entrance port of the laser annealing apparatus 14.

The laser annealing apparatus 14 includes an irradiation optical system 70, a frame 72, an XYZ stage 74, a table 76, and a laser annealing control processor 100.

The irradiation optical system 70 includes high reflective mirrors 111, 112, 113, an attenuator 120, an illumination optical system 130, a mask 140, a projection optical system 142, a window 146, and a housing 150. The irradiation optical system 70 is an example of an “optical system” in the present disclosure.

The high reflective mirror 111 is disposed such that a pulse laser beam that has passed through the optical path tube 13 passes through the attenuator 120 and is incident on the high reflective mirror 112.

The attenuator 120 is disposed on an optical path between the high reflective mirror 111 and the high reflective mirror 112. The attenuator 120 includes two partial reflective mirrors 121, 122 and rotation stages 123, 124 that can change the incident angle on the respective mirrors.

The high reflective mirror 112 is disposed such that a pulse laser beam that has passed through the attenuator 120 is incident on the high reflective mirror 113. The high reflective mirror 113 is disposed such that the pulse laser beam that has been incident on the high reflective mirror 113 is incident on a fly-eye lens 134 of the illumination optical system 130.

The illumination optical system 130 includes the fly-eye lens 134 and a condenser lens 136. The illumination optical system 130 is disposed to perform Köhler illumination on the mask 140 with a rectangular beam. The rectangular beam refers to a rectangular-shaped beam having a uniform light intensity distribution in the beam.

The fly-eye lens 134 is disposed such that a focal plane of the fly-eye lens 134 and a front focal plane of the condenser lens 136 coincide with each other, for example. The condenser lens 136 is disposed such that a rear focal plane of the condenser lens 136 and the position of the mask 140 coincide with each other.

The mask 140 is a photomask in which a pattern of metal or a dielectric multilayer film is formed on a synthetic quartz substrate that transmits ultraviolet light, for example. For example, a line-and-space pattern is formed on the mask 140.

The projection optical system 142 is disposed such that an image of the mask 140 is formed on a front surface of an object to be irradiated 160 through the window 146. The projection optical system 142 is a combination lens of a plurality of lenses 143, 144 and may be a reduction projection optical system.

The window 146 is disposed on a pulse laser beam path between the projection optical system 142 and the object to be irradiated 160. The window 146 is disposed in a hole provided in the housing 150 via an O-ring (not shown) or the like. The window 146 may be a CaF2 crystal or a synthetic quartz substrate that transmits an excimer laser beam, and both surfaces thereof may be coated with a reflection-suppressing film.

An inlet 152 and an outlet 154 for N₂ gas are provided in the housing 150. A N₂ gas supply source is connected to the inlet 152 via a pipe (not shown). The housing 150 may be sealed with an O-ring or the like so as to suppress outside air from entering the housing 150.

The irradiation optical system 70 and the XYZ stage 74 are fixed to the frame 72. The table 76 is fixed on the XYZ stage 74. The object to be irradiated 160 is fixed on the table 76. The table 76 is an example of a placing table on which the object to be irradiated 160 is placed.

The object to be irradiated 160 may be a PET substrate in which a substrate is coated with an a-ITO thin film, for example.

### 2.2 Operation

The laser annealing control processor 100 reads irradiation condition parameters at the time of laser annealing. Specifically, the laser annealing control processor 100 reads a target fluence Fa, a target pulse energy Et, the number of irradiated pulses Na, and a repetition frequency fa at the time of laser annealing.

The laser annealing control processor 100 transmits the target pulse energy Et to the laser control processor 28 and transmits a light emission trigger Tr1 corresponding to the number of irradiated pulses Na and the repetition frequency fa to the laser control processor 28.

The laser control processor 28 receives the target pulse energy Et from the laser annealing control processor 100.

The laser control processor 28 receives the light emission trigger Tr1 of the repetition frequency fa and controls the oscillator 20 to oscillate at the repetition frequency fa.

The pulse laser beam output from the oscillator 20 is sampled by the beam splitter 50 of the monitor module 24, and a pulse energy E is measured by the optical sensor 52. The laser control processor 28 controls charging voltage of the charger 36 such that a difference ΔE between the pulse energy E and the target pulse energy Et approaches zero.

The pulse laser beam transmitted through the beam splitter 50 of the monitor module 24 enters the laser annealing apparatus 14 via the optical path tube 13.

The pulse laser beam that has entered the laser annealing apparatus 14 is reflected by the high reflective mirror 111, is attenuated by passing through the attenuator 120, and is reflected by the high reflective mirror 112. At this time, the laser annealing control processor 100 controls the incident angles on the two partial reflective mirrors 121, 122 by the respective rotation stages 123, 124 such that the fluence at the position of the front surface (the image of the mask 140) of the object to be irradiated 160 becomes the target fluence Fa.

The pulse laser beam that has been highly reflected at the high reflective mirror 112 and the high reflective mirror 113 illuminates a place on the mask 140 at a light intensity that has been spatially uniformized by the illumination optical system 130.

The pulse laser beam transmitted through the mask 140 is projected onto the front surface of the object to be irradiated 160 by the projection optical system 142.

The laser annealing control processor 100 controls the XYZ stage 74 such that the image of the mask 140 to be transferred by the projection optical system 142 is projected to an appropriate position.

The pulse laser beam irradiates the object to be irradiated 160 in a region in which the transferred image is formed by passing through the projection optical system 142. As a result, a portion in the front surface of the object to be irradiated 160 that is irradiated with the pulse laser beam is annealed.

An excimer laser can efficiently heat a relatively shallow front surface of the irradiated material. Therefore, with laser annealing treatment using the laser apparatus 12, it is possible to polycrystallize a thin film of ITO or the like generated on a substrate with low heat-resistant temperature with reduced influence on the substrate.

### 3. Problem 1

Specific descriptions will be made below by using the ITO thin film as an example. In the field of laser annealing, it is required to shorten the processing time and improve the processing amount (throughput) per unit time. In order to meet such demands, a method of increasing the laser fluence is conceivable. However, when the laser fluence is increased, laser ablation of the ITO thin film may occur. There may be cases in which the ITO thin film cannot retain not only electrical conductivity but also transparency due to damages in accordance with ablation. Therefore, the laser fluence is limited to a value with which laser ablation does not occur in the ITO thin film.

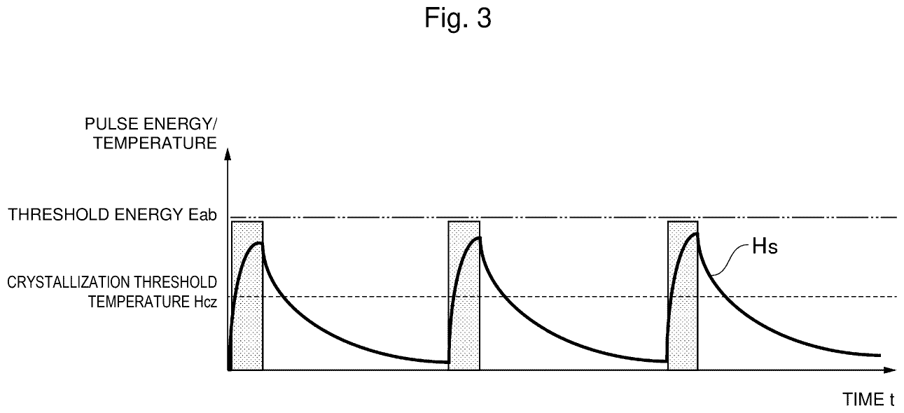

FIG. 3 is a graph showing the pulse energy of a pulse laser beam with which an ITO thin film is irradiated in laser annealing treatment according to Comparative Example 1 and the change in the temperature in the vicinity of a front surface of the ITO thin film in accordance with laser irradiation. The comparative example is a form recognized by the applicant as known only by the applicant and is not a publicly known example admitted by the applicant.

In FIG. 3, an example in which irradiation with a plurality of pulse laser beams is intermittently performed at a predetermined time interval is shown, and three pulses are shown in FIG. 3. In FIG. 3, the vertical axis represents pulse energy or temperature, and the horizontal axis represents time. A temperature Hs in the vicinity of the front surface of the ITO thin film (hereinafter referred to as a thin film surface temperature Hs) is indicated by a solid line, and the pulse energy of the pulse laser beam is schematically indicated by hatched blocks.

In order to crystallize an ITO thin film in an amorphous state by laser annealing, the surface temperature Hs of the ITO thin film needs to be increased to a temperature equal to or higher than a crystallization threshold temperature Hcz. Therefore, the pulse energy of the pulse laser beam needs to be of a certain magnitude. The crystallization threshold temperature Hcz is a temperature at which crystallization occurs and is synonymous with a crystallization temperature.

Meanwhile, when irradiation with a pulse laser beam having a high fluence exceeding an ablation threshold of the ITO thin film is performed, the ITO thin film itself causes ablation. Therefore, the fluence of the pulse laser beam is limited to a value less than the ablation threshold. The ablation threshold is a lower limit value of a laser fluence at which laser ablation occurs.

As shown in FIG. 3, the pulse energy of the pulse laser beam with which the ITO thin film is irradiated is set to be less than a threshold energy Eab at which laser ablation does not occur. The threshold energy Eab is equivalent to a value obtained by converting the ablation threshold into energy.

In other words, in the laser annealing treatment according to Comparative Example 1 shown in FIG. 3, the pulse energy of the pulse laser beam is moderately adjusted, the thin film surface temperature Hs is increased to a temperature equal to or higher than the crystallization threshold temperature Hcz within the duration of each pulse, and irradiation with the laser beam is performed under a condition of a fluence that does not cause laser ablation.

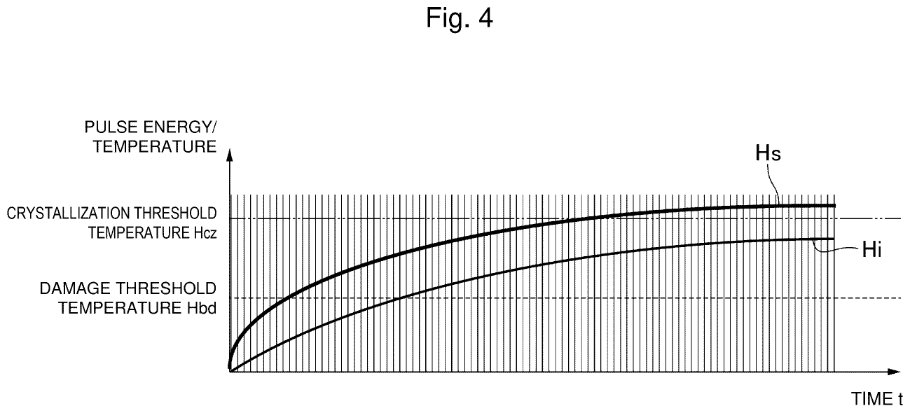

Meanwhile, as another method of improving the throughput, a method of increasing the repetition of laser irradiation is conceivable. An example is shown in FIG. 4. FIG. 4 is a graph showing an example of the pulse energy of a pulse laser beam with which an ITO thin film is irradiated in laser annealing treatment according to Comparative Example 2, the change in the thin film surface temperature Hs in accordance with the laser irradiation, and the change in a temperature Hi of an interface between the ITO thin film and a substrate (hereinafter referred to as an interface temperature Hi). The interface temperature Hi may be understood as a substrate temperature in the vicinity of the interface between the ITO thin film and the substrate.

FIG. 4 shows an example of a case in which irradiation with the pulse laser beam is performed at a predetermined repetition frequency for a predetermined period of time. In FIG. 4, the vertical axis represents pulse energy or temperature, and the horizontal axis represents time. As shown in FIG. 4, when the repetition of the pulse laser beam with which the ITO thin film is irradiated is increased, heat may be accumulated in the ITO thin film, and the thin film surface temperature Hs may be maintained for a long time at a temperature equal to or higher than the crystallization threshold temperature Hcz. When this state continues, crystal nuclei continue to be generated, and the final crystal grains become smaller.

In addition, a heat storage effect due to the increase in repetition causes thermal invasion not only in the vicinity of the front surface of the ITO thin film but also to the interface between the ITO thin film and the substrate. When heat storage continues, the interface temperature Hi may exceed a damage threshold temperature Hbd of the substrate, thereby causing substrate damage. When the substrate exceeds the damage threshold temperature Hbd, the substrate receives irreversible damage such as surface roughness or thin film peeling. The damage threshold temperature Hbd varies depending on the material.

Therefore, in addition to the fluence, the repetition frequency of the pulse laser beam has also been limited, and the number of times of irradiation required to reach crystallization has been extremely large.

As described above, throughput has been limited when a thin film such as an ITO thin film or an IGZO film is polycrystallized by laser annealing. In particular, the influence thereof has been remarkable when the substrate is made of a material with low heat resistance such as PET resin or polycarbonate (PC).

Therefore, there has been a demand for a laser annealing technology that does not inhibit crystal growth and improves throughput while suppressing substrate damage.

### 4. Embodiment 1

### 4.1 Configuration

A device configuration of a laser annealing system according to Embodiment 1 is similar to that of the laser annealing system 10 shown in FIG. 2. Hereinafter, in the description of Embodiment 1, the same reference characters as those in the configuration shown in FIG. 2 are used.

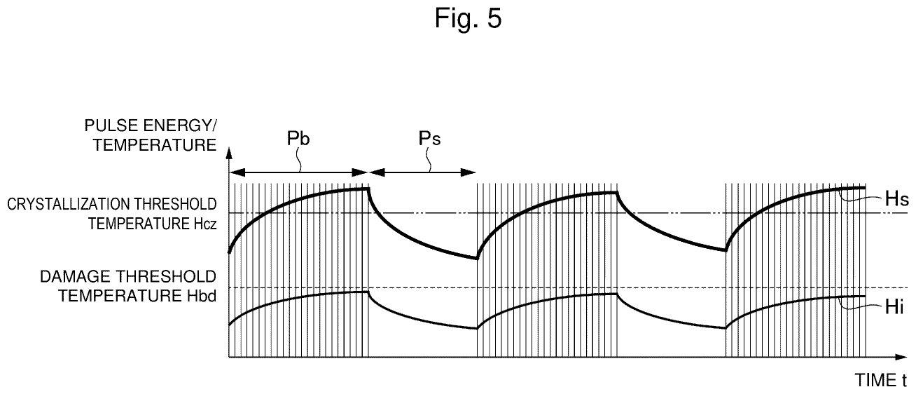

In the laser annealing system 10 according to Embodiment 1, instead of performing irradiation with the pulse laser beam at a predetermined repetition frequency for a predetermined period of time, burst irradiation in which a burst period Pb and a suspension period Ps are alternated is performed as shown in FIG. 5. The laser annealing control processor 100 and the laser control processor 28 control the heat input to the object to be irradiated 160 by adjusting, in the burst operation, the repetition frequency, the pulse energy, and the number of pulses in the burst period, and the length of the suspension period.

In other words, the laser annealing control processor 100 and the laser control processor 28 control the heat storage in the object to be irradiated 160 such that a temperature lower than the damage threshold temperature Hbd is maintained in the vicinity of the substrate including the interface between the ITO thin film and the substrate while the state of the temperature exceeding the crystallization threshold temperature Hcz is maintained as much as possible for the ITO thin film front surface.

Irradiation condition parameters of the burst irradiation related to the control of the heat storage are adjusted by the material and the thickness of each of the thin film and the substrate. The laser annealing control processor 100 and the laser control processor 28 are examples of a processor in the present disclosure.

In the laser annealing system 10, it becomes possible to reduce damage to the substrate due to a temperature difference in the thickness direction by supplementarily providing a cooling mechanism on a lower surface of the substrate.

### 4.2 Operation

With reference to FIG. 5, features of the operation of the laser annealing system 10 according to Embodiment 1 that are different from those of FIG. 4 will be described in detail. FIG. 5 is a graph showing an example of burst irradiation performed by the laser annealing system 10 according to Embodiment 1 and an example of the changes in the thin film surface temperature Hs and the interface temperature Hi in accordance with the burst irradiation. The vertical axis and the horizontal axis in FIG. 5 are similar to those in FIG. 4.

As shown in FIG. 5, the laser annealing system 10 performs burst irradiation in which the burst period Pb in which irradiation with the pulse laser beam is continuously performed and the suspension period Ps in which the irradiation with the pulse laser beam is stopped are alternately repeated, thereby irradiating the same section of the ITO thin film with the pulse laser beam in a plurality of burst periods. The suspension period Ps is an example of a “suppression period” of the present disclosure.

The laser annealing control processor 100 and the laser control processor 28 control the thin film surface temperature Hs and the interface temperature Hi by controlling the heat input and the heat storage with respect to the object to be irradiated 160 by adjusting irradiation conditions of the burst irradiation.

The irradiation conditions for the burst irradiation include parameters such as the pulse energy, the repetition frequency, and the number of pulses of the pulse laser beam within the burst period Pb, and the length of the suspension period Ps. The number of pulses in the burst period Pb is related to the length of the burst period Pb. The length of the burst period Pb may be used instead of the number of pulses. The laser fluence is set to be lower than the ablation threshold as described in FIG. 3.

As shown in FIG. 5, during the burst period Pb, each of the thin film surface temperature Hs and the interface temperature Hi gradually increases and a state in which the thin film surface temperature Hs exceeds the crystallization threshold temperature Hcz is maintained for a certain period of time by continuous irradiation with pulse laser beams including a plurality of pulses within the burst period Pb.

Then, when transition is made to the suspension period Ps, the heat input is stopped. As a result, the thin film surface temperature Hs and the interface temperature Hi gradually decrease during the suspension period Ps. In the suspension period Ps, the thin film surface temperature Hs may be placed in a state of being lower than the crystallization threshold temperature Hcz.

The interface temperature Hi remains to be lower than the damage threshold temperature Hbd for the burst period Pb and the suspension period Ps. In other words, in the burst period Pb, the interface temperature Hi gradually increases, but the burst period Pb is terminated, and transition is made to the suspension period Ps before the damage threshold temperature Hbd is reached. The burst period Pb and the suspension period Ps are alternated thereafter.

### 4.3 Effect

With the burst irradiation of Embodiment 1, it is possible to maintain a state in which the thin film surface temperature Hs is equal to or higher than the crystallization threshold temperature Hcz for a required period of time and to minimize the influence of heat on the substrate that is a foundation layer. Therefore, according to Embodiment 1, it is possible to improve the throughput of the annealing treatment of the ITO thin film or IGZO thin film formed on a low-temperature-resistant substrate of PET resin, PC, or the like.

According to Embodiment 1, it is possible to laser-anneal the thin film front surface at a temperature equal to or higher than the crystallization threshold temperature Hcz and to laser-anneal the vicinity of the substrate including the interface between the ITO thin film and the substrate at a temperature lower than the damage threshold temperature Hbd. Therefore, it is possible to efficiently perform the generation and growth of the crystal nuclei while suppressing substrate damage. It is also possible to improve the electrical conductivity and the characteristics of the electrode material such as mobility.

### 4.4 Modification 1 of Embodiment 1

### 4.4.1 Configuration

A configuration of a laser annealing system according to Modification 1 of Embodiment 1 is similar to that of the laser annealing system 10.

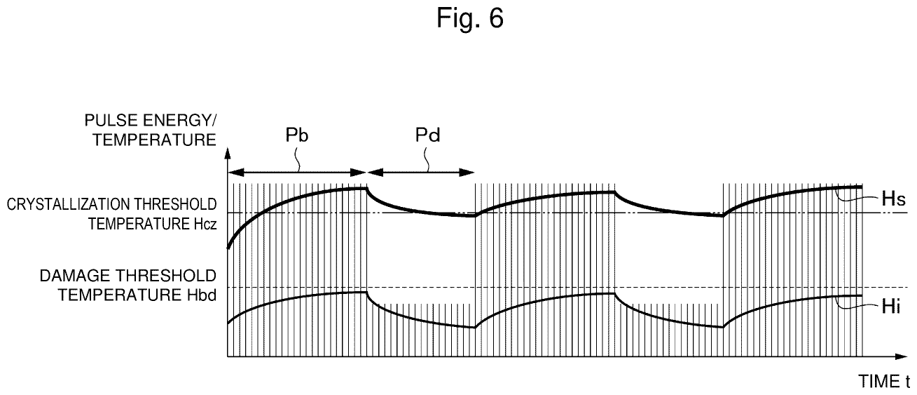

In FIG. 5, the suspension period Ps of the burst irradiation is described as a period of time in which the pulse energy becomes completely zero and the laser irradiation is stopped, but the pulse energy does not necessarily need to be completely zero in the period of time corresponding to the suspension period Ps. In other words, as shown in FIG. 6, a low output period Pd in which irradiation with a pulse laser beam adjusted to a pulse energy lower than that in the burst period Pb is performed may be used instead of the suspension period Ps. The low output period Pd is an example of a “suppression period” in the present disclosure.

### 4.4.2 Operation

FIG. 6 is a graph showing an example of burst irradiation performed by the laser annealing system 10 according to Modification 1 of Embodiment 1 and an example of the changes in the thin film surface temperature Hs and the interface temperature Hi in accordance with the burst irradiation. The vertical axis and the horizontal axis in FIG. 6 are similar to those in FIG. 3. Burst irradiation as that in FIG. 6 may be employed instead of that in FIG. 5.

As shown in FIG. 6, the laser annealing control processor 100 and the laser control processor 28 may suppress the heat storage by setting the pulse energy of the pulse laser beam with which irradiation is performed in the low output period Pd in place of the suspension period Ps to be lower than the pulse energy in the burst period Pb. In the example of FIG. 6, the pulse energy of the low output period Pd is set such that the state in which the thin film surface temperature Hs is equal to or higher than the crystallization threshold temperature Hcz is substantially maintained during the low output period Pd, but the thin film surface temperature Hs during the low output period Pd may be set to be lower than the crystallization threshold temperature Hcz as a result of adjusting the pulse energy during the low output period Pd.

### 4.4.3 Effect

According to Modification 1 of Embodiment 1, it is possible to improve the flexibility of the heat storage control of the object to be irradiated 160 by adjusting the pulse energy of the pulse laser beam with which irradiation is performed in the low output period Pd after the burst period Pb.

### 4.5 Modification 2 of Embodiment 1

### 4.5.1 Configuration

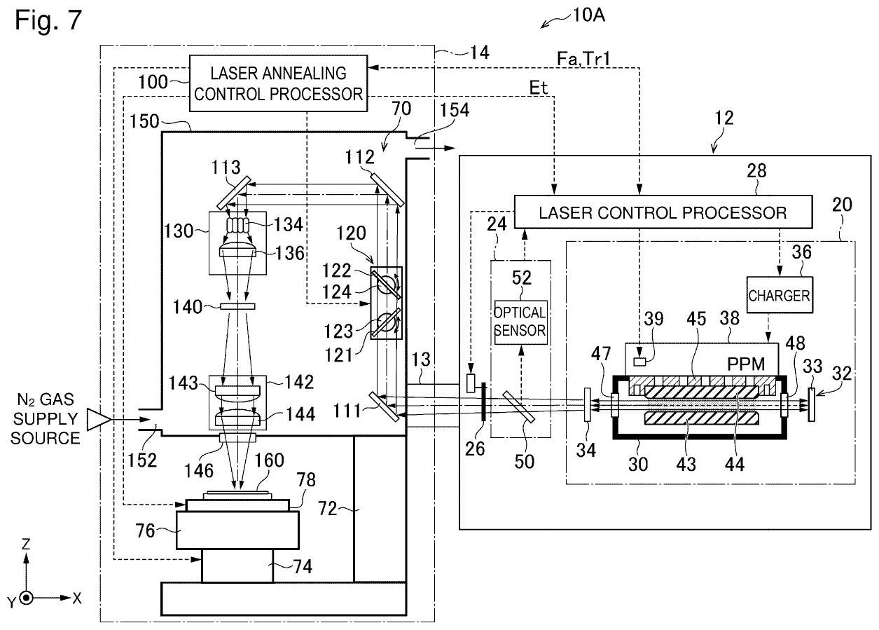

FIG. 7 schematically shows a configuration of a laser annealing system 10A according to Modification 2 of Embodiment 1. The configuration shown in FIG. 7 will be described with respect to features different from those of the configuration shown in FIG. 2.

The laser annealing system 10A includes a cooling plate 78 on a surface of the table 76 on which the object to be irradiated 160 is placed. The cooling plate 78 may be a water-cooling system or a Peltier element. The cooling plate 78 is an example of a cooling mechanism in the present disclosure. The cooling plate 78 may be connected to the laser annealing control processor 100 such that the ON and OFF of the cooling can be controlled. The ON and OFF of the cooling are controlled by the opening and closing of a valve of the water-cooling system, the ON and OFF of a current of the Peltier element, and the like.

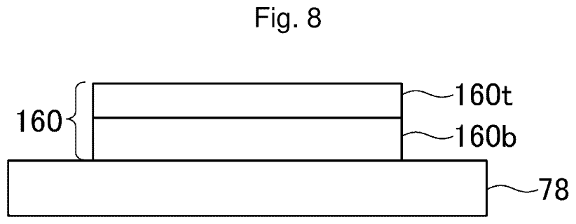

FIG. 8 is an enlarged side view of the cooling plate 78 and the object to be irradiated 160 shown in FIG. 7. The object to be irradiated 160 has a structure in which an object to be heated 160t to be heated by laser irradiation and a non-heatable member 160b for which the influence of heat caused by laser irradiation is desired to be avoided as much as possible are stacked. The object to be heated 160t is a thin film that is annealed by the laser annealing system 10A and is an ITO thin film or an IGZO thin film, for example. The non-heatable member 160b is a substrate made of a material that has poor heat resistance and is a resin substrate made of PET resin, PC, or the like.

### 4.5.2 Operation

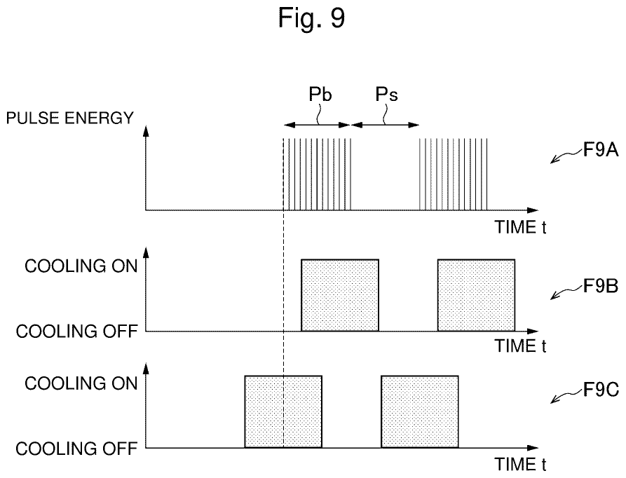

The laser annealing control processor 100 performs control of turning the cooling operation of the cooling plate 78 ON and OFF in synchronization with the burst operation. FIG. 9 is a timing chart showing control examples of a cooling operation.

A graph F9A in the top row of FIG. 9 shows the burst period Pb and the suspension period Ps of the burst operation. A graph F9B in the middle row shows Control Example 1 of the cooling operation of the cooling plate 78, and a graph F9C in the lower row shows Control Example 2.

A timing of “cooling ON” may be set to be delayed (graph F9B) from a timing of starting the burst period Pb or may be set to precede (graph F9C) the timing of starting the burst period Pb. The laser annealing control processor 100 adjusts the thermal distribution in the thickness direction of the object to be irradiated 160 by turning ON the cooling such that the cooling is delayed from the burst period Pb or turning ON the cooling such that the cooling is earlier than the burst period Pb.

The length of the period of time of “cooling ON” does not necessarily need to be the same as the bursting period Pb. The timing of turning ON the cooling and the length of the period of time of “cooling ON” are adjusted such that a targeted thermal distribution is obtained.

### 4.5.3 Effect

The cooling plate 78 can remove heat transmitted to the substrate that is the non-heatable member 160b, and hence it is possible to suppress substrate damage caused by the influence of heat more effectively.

With the laser annealing system 10A, an effect of controlling the temperature gradient of the object to be irradiated 160 in the thickness direction is obtained by the cooling operation using the cooling plate 78. Therefore, it is possible to easily control the temperature of the thin film that is the object to be heated 160t while preventing the temperature rise of the substrate.

### 5. Problem 2

Regarding the ITO thin film, an electrode having a lower resistivity and a higher mobility is easily realized by increasing the size of the crystal grains when crystallization is performed by the laser annealing treatment. The energy required for crystallization from the amorphous state is conceived to be expressed by a relation of [formation of crystal nuclei]>[growth of crystal grains]. Therefore, it has been devised to cause growth in two stages for the formation of crystal nuclei and the growth of crystal grains, and such a method has been realized in normal atmosphere annealing and the like.

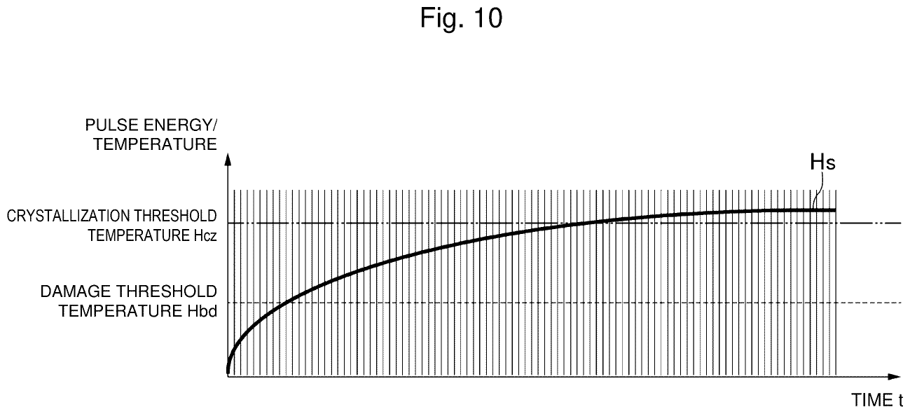

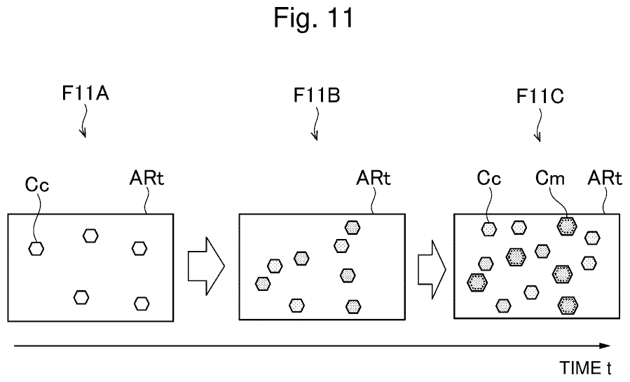

However, in the laser annealing treatment by the continuous irradiation with the pulse laser beam as shown in FIG. 10, the thin film surface temperature Hs continues to increase beyond the crystallization threshold temperature Hcz, and the crystal grain growth is performed in a state in which the temperature is equal to or higher than the crystal nucleus generation threshold temperature. Therefore, the crystal nuclei continue to be generated, and the final crystal grains become small (see FIG. 11). This is because, at a temperature equal to or higher than the crystal nucleus generation threshold temperature, the formation of the crystal nuclei occurs more easily as compared to the crystal growth.

FIG. 10 shows the change in the thin film surface temperature Hs in accordance with the continuous irradiation with the pulse laser beam as in FIG. 4. FIG. 11 is an explanatory diagram schematically showing a process of crystallization of a thin film in accordance with continuous irradiation with the pulse laser beam shown in FIG. 10. FIG. 11 shows the passage of time from left to right. In FIG. 11, in an irradiated area ARt of the thin film, the generation of crystal nuclei Cc and the crystal growth occur over time.

A left diagram F11A in FIG. 11 shows a state in which the thin film surface temperature Hs has exceeded the crystal nucleus generation threshold temperature and the crystal nuclei Cc are generated. A central diagram F11B shows a state in which the crystal nuclei Cc are increased by the formation of new crystal nuclei Cc and crystal grains grow. A right diagram F11C shows a state in which the crystal nuclei Cc are further increased by the formation of the new crystal nuclei Cc and crystal grains Cm grow from the state of the central diagram F11B.

When the crystal nuclei CC increase, the crystal grains Cm cannot grow sufficiently large and become moderate crystal grains Cm. As described above, when the pulse laser beam is continuously irradiated in a highly repeated manner, the crystal grains are grown in a state in which the temperature is equal to or higher than the crystal nucleus generation threshold temperature. Therefore, new crystal nuclei Cc are continuously generated, and the final size of the individual crystal grain Cm remains relatively small.

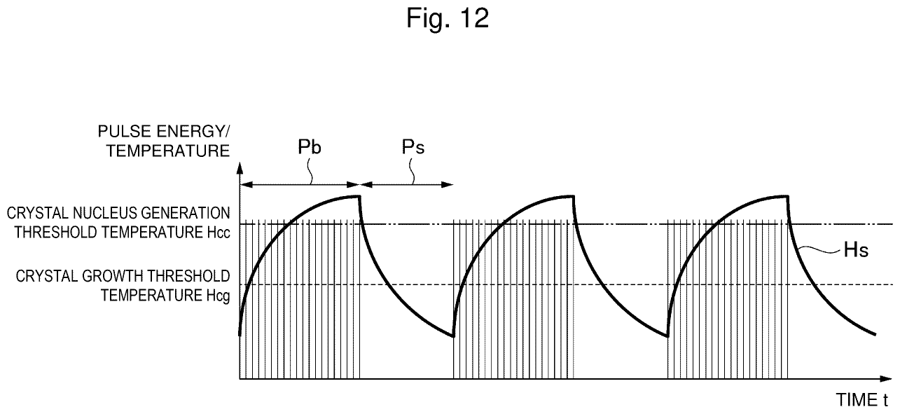

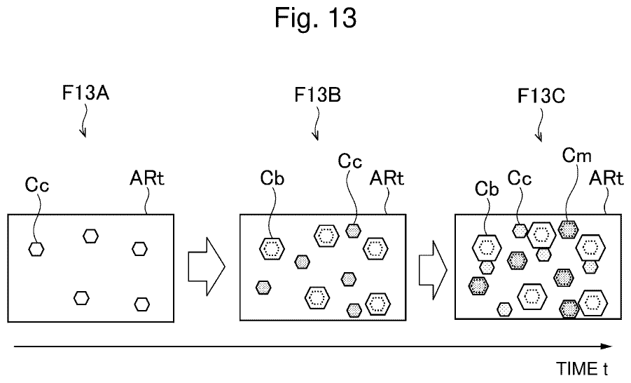

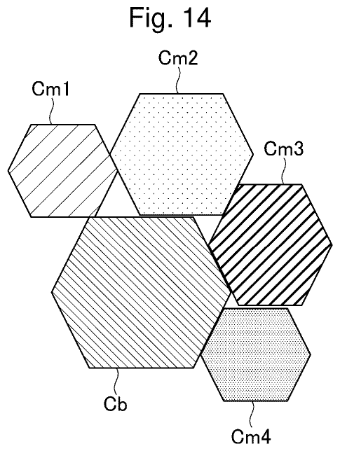

Meanwhile, in the burst irradiation with a simple burst pulse as with that shown in FIG. 12, new crystal nuclei are generated at the same time as the crystal grains are grown. In this case, the crystal orientation of each of the generated crystal grains varies, and hence it is difficult for the crystal grains to grow in a combined manner even when the crystal grains are adjacent to each other. Therefore, the size of the crystal grains does not become larger (see FIGS. 13 and 14).

FIG. 12 is a graph showing an example of a burst pattern and an example of the change in the thin film surface temperature Hs in accordance with the burst irradiation. In the burst irradiation shown in FIG. 12, the thin film surface temperature Hs increases to a state of being equal to or higher than a crystal nucleus generation threshold temperature Hcc during the burst period Pb, and the thin film surface temperature Hs decreases to a state of being lower than the crystal growth threshold temperature Hcg in the suspension period Ps. By alternating the burst period Pb and the suspension period Ps, the state in which the thin film surface temperature Hs is equal to or higher than the crystal nucleus generation threshold temperature Hcc and the state in which the thin film surface temperature Hs is lower than the crystal growth threshold temperature Hcg are intermittently repeated, and the crystal grains grow while the new crystal nuclei are generated.

FIG. 13 is an explanatory diagram schematically showing a process of crystallization of the thin film in accordance with the burst irradiation shown in FIG. 12. In FIG. 13, in the irradiated area ARt of the thin film, the generation of the crystal nuclei Cc and the crystal growth occur over time. Regarding FIG. 13, features different from those in FIG. 11 will be described.

A left diagram F13A of FIG. 13 shows a state in which the thin film surface temperature Hs has exceeded the crystal nucleus generation threshold temperature Hcc and the crystal nuclei Cc are generated. The central diagram F13B shows a state in which the crystal nuclei Cc grow into crystal grains Cb while the new crystal nuclei Cc are increased as a result of the thin film surface temperature Hs intermittently becoming equal to or higher than the crystal nucleus generation threshold temperature Hcc and intermittently becoming equal to or higher than the crystal growth threshold temperature Hcg.

The right diagram F13C shows a state in which the new nuclei Cc are further generated and the grains Cm, Cb further grow from the state of the central diagram F13B.

As above, in the burst irradiation shown in FIG. 12, the generation of new crystal nuclei Cc and the growth of the crystal grain Cm, Cb occur simultaneously.

FIG. 14 schematically shows crystal grains produced by the burst irradiation shown in FIG. 12. As shown in FIG. 14, the crystal grains Cb, Cm1, Cm2, Cm3, Cm4 produced by the burst irradiation of FIG. 12 differ in their respective crystal orientations. Therefore, even when the crystal grains are adjacent to each other, it is difficult for the crystal grains to grow in a combined manner, and the size of the final crystal grains does not become so large.

In view of such circumstances, there has been a demand for a laser annealing method that improves throughput without inhibiting crystal growth.

### 6. Embodiment 2

### 6.1 Configuration

A device configuration of a laser annealing system according to Embodiment 2 is similar to that of the laser annealing system 10 shown in FIG. 2 or the laser annealing system 10A shown in FIG. 7. Hereinafter, in the description of Embodiment 2, the same reference numerals as those in the configuration shown in FIG. 2 are used.

### 6.2 Operation

In the laser annealing system 10 according to Embodiment 2, irradiation during a burst period on the leading side in the burst irradiation may be different from other subsequent burst periods. For example, by performing laser irradiation during the burst period on the leading side with a higher energy than the other subsequent burst periods, the thin film surface temperature Hs is raised to a temperature equal to or higher than the crystal nucleus generation threshold temperature Hcc. In the subsequent burst periods, a temperature equal to or higher than the crystal growth threshold temperature Hcg is realized while the thin film surface temperature Hs is maintained at a temperature lower than the crystal nucleus generation threshold temperature Hcc as low-energy laser irradiation. Thus, the crystal can be grown in two stages. The burst period on the leading side in which high-energy laser irradiation is performed may be a plurality of burst periods including a leading burst period.

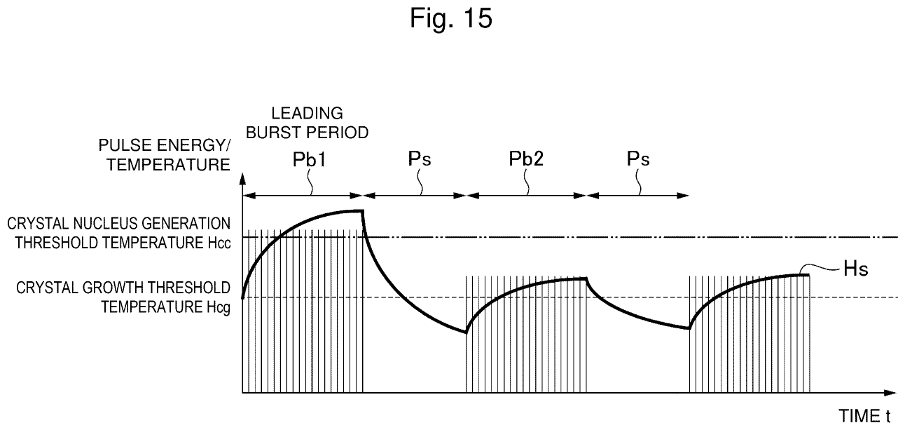

FIG. 15 is a graph showing an example of burst irradiation of the laser annealing system 10 according to Embodiment 2 and an example of the change in the thin film surface temperature Hs in accordance with the burst irradiation. The vertical axis and the horizontal axis in FIG. 15 are similar to those in FIG. 12.

As shown in FIG. 15, the laser annealing control processor 100 sets the pulse energy in a leading burst period Pb1 in the burst operation to be higher than the pulse energy in a next burst period Pb2. The repetition frequency in the respective burst periods Pb1, Pb2 may be the same.

By laser irradiation in the leading burst period Pb1, the thin film surface temperature Hs is placed in a state of being equal to or higher than the crystal nucleus generation threshold temperature Hcc, and crystal nuclei are generated. Then, the laser irradiation is controlled such that the pulse energy in other burst periods including the next (second) burst period Pb2 is set to be lower than the pulse energy in the leading burst period Pb1, the thin film surface temperature Hs is maintained at a temperature lower than the crystal nucleus generation threshold temperature Hcc during the other burst periods, and the time in which the temperature is maintained to be equal to or higher than the crystal growth threshold temperature Hcg is as long as possible. The laser irradiation conditions (the pulse energy, the repetition frequency, and the number of pulses) applied in the second burst period and burst periods thereafter may be the same conditions. As a result, the crystal can be grown in two stages: the generation of the crystal nuclei and the growth of the crystal grains.

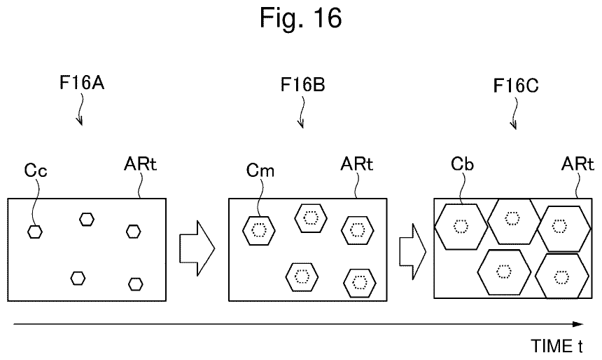

FIG. 16 is an explanatory diagram schematically showing a process of crystallization of the thin film by the burst irradiation shown in FIG. 15. Regarding FIG. 16, features different from those in FIG. 13 will be described.

A left diagram F16A of FIG. 16 shows a state in which the crystal nuclei Cc are generated by laser irradiation in the leading burst period Pb1. Then, as shown in a central diagram F16B, by laser irradiation in the second burst period Pb2, the generation of new crystal nuclei Cc is suppressed, and the existing crystal nuclei Cc grow to become crystal grains Cm. As shown in a right diagram F16C, by laser irradiation in a third burst period and burst periods thereafter, the generation of new crystal nuclei Cc is suppressed, and the existing crystal grains Cm grow, thereby resulting in larger crystal grains Cb.

### 6.3 Effect

According to Embodiment 2, the crystal can be grown in two stages, and hence a crystal having a high mobility and a large size is easily obtained.

### 6.4 Modification 1 of Embodiment 2

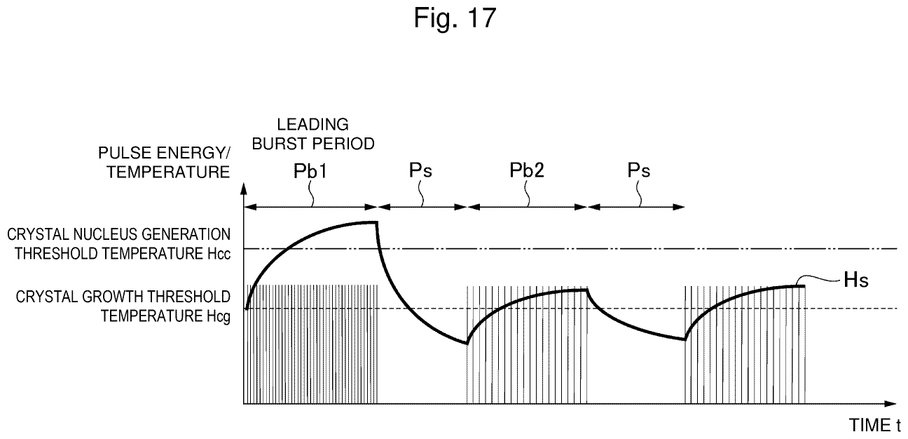

The burst period on the leading side is not limited to an aspect in which the pulse energy is changed as compared with the other burst periods, and, for example, a repetition frequency different from that in the other burst periods may be set for the burst period on the leading side. For example, the burst period on the leading side may have a higher repetition frequency than the other burst periods (see FIG. 17).

FIG. 17 shows an example of burst irradiation according to Modification 1 of Embodiment 2 and an example of the change in the thin film surface temperature Hs in accordance with the burst irradiation. The vertical axis and the horizontal axis in FIG. 17 are similar to those in FIG. 15.

As shown in FIG. 17, the laser annealing control processor 100 sets the repetition frequency in the leading burst period Pb1 to be higher than the repetition frequency in the next burst period Pb2 in the burst operation. The pulse energy in the respective burst periods Pb1, Pb2 may be the same.

By laser irradiation in the leading burst period Pb1, the thin film surface temperature Hs is placed in a state of being equal to or higher than the crystal nucleus generation threshold temperature Hcc, and crystal nuclei are generated. Then, the laser irradiation is controlled such that the repetition frequency in other burst periods including the next (second) burst period Pb2 is set to be lower than the repetition frequency in the leading burst period Pb1, the thin film surface temperature Hs is maintained at a temperature lower than the crystal nucleus generation threshold temperature Hcc during the other burst periods, and the time in which the temperature is maintained to be equal to or higher than the crystal growth threshold temperature Hcg is as long as possible. The laser irradiation conditions (the pulse energy, the repetition frequency, and the number of pulses) applied in the second burst period and the burst periods thereafter may be the same conditions. As a result, the crystal can be grown in two stages: the generation of the crystal nuclei and the growth of the crystal grains.

### 6.5 Modification 2 of Embodiment 2

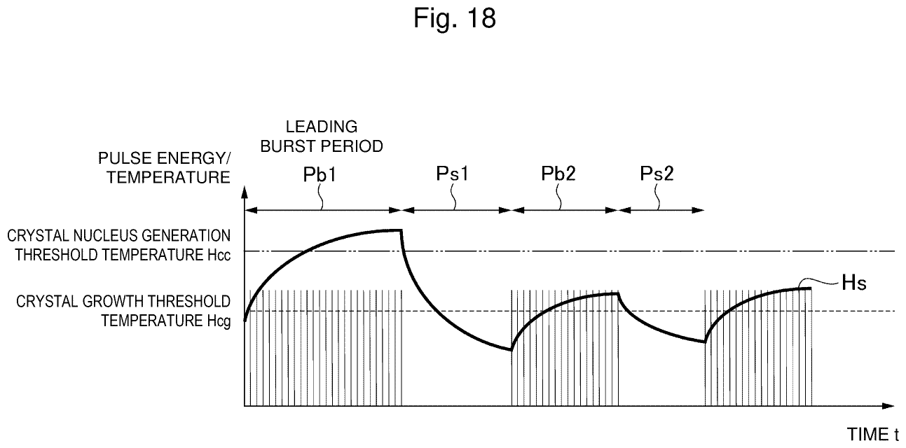

The burst period on the leading side may be set such that the number of pulses (burst time) is different from that in the other burst periods. For example, the number of pulses may be larger in the burst period on the leading side than in the other burst periods (see FIG. 18). At this time, the suspension period after the burst period on the leading side may be set to a length different from the other suspension periods.

FIG. 18 shows an example of burst irradiation according to Modification 2 of Embodiment 2 and an example of the change in thin film surface temperature Hs in accordance with the burst irradiation. The vertical axis and the horizontal axis in FIG. 18 are similar to those in FIG. 15.

As shown in FIG. 18, the laser annealing control processor 100 may set the number of pulses in the leading burst period Pb1 in the burst operation to be larger than the number of pulses of the next burst period Pb2. The pulse energy and the repetition frequency in the burst periods Pb1, Pb2 may be the same.

The laser annealing control processor 100 may set a suspension period Ps1 immediately after the leading burst period Pb1 to be longer than other suspension periods Ps2.

By such burst irradiation, the crystal can be grown in two stages as in the examples of FIGS. 15 and 17.

### 6.6 Other

Embodiment 2 and Modifications 1 and 2 thereof may be combined, as appropriate. For example, the laser annealing control processor 100 may perform the laser irradiation in the leading burst period Pb1 at a higher energy and a higher repetition frequency than the other burst periods. For example, the laser annealing control processor 100 may set the laser irradiation in the leading burst period Pb1 at a higher energy and a lower repetition frequency or at a higher repetition frequency and a smaller number of pulses than the other burst periods.

Some or all of the suspension periods in Embodiment 2 and Modifications 1 and 2 thereof may be set be the low output periods Pd as those shown in FIG. 6.

### 7. Embodiment 3

### 7.1 Configuration

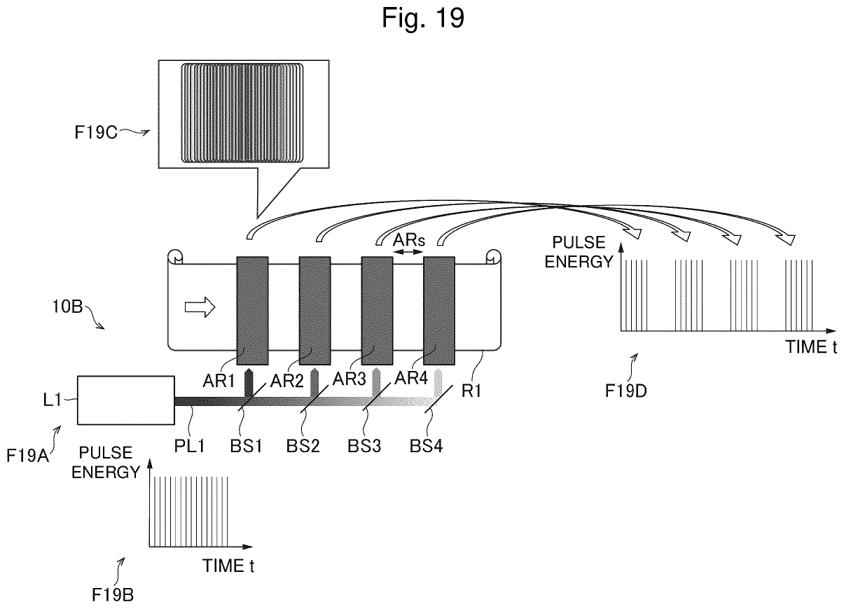

FIG. 19 schematically shows a configuration of a laser annealing system 10B according to Embodiment 3. The laser annealing system 10B performs annealing treatment on a web-shaped object to be irradiated R1 by a roll-to-roll process. The object to be irradiated R1 may be a resin roll in which a thin film is formed on a resin substrate, for example.

As shown in a central diagram F19A of FIG. 19, the laser annealing system 10B includes a conveyance mechanism (not shown) that conveys the object to be irradiated R1 by a roll-to-roll method, a laser apparatus L1, and a distribution optical system including a plurality of beam splitters BS1, BS2, BS3, BS4 for distributing a pulse laser beam PL1 output from the laser apparatus L1 to a plurality of irradiation areas AR1, AR2, AR3, AR4.

Although FIG. 19 shows a configuration including four irradiation areas AR1, AR2, AR3, AR4, the number of the irradiation areas is not limited to this example. The number of beam splitters is also varied depending on the number of irradiation areas.

The conveyance mechanism includes known configurations such as an unwinding roller, a winding roller, and a pass roller.

Each of the irradiation areas AR1, AR2, AR3, AR4 is an area in which the object to be irradiated R1 is irradiated with the pulse laser beam. Pulse laser beams are distributed such that the irradiation areas AR1, AR2, AR3, AR4 are disposed at predetermined intervals along the moving direction of the object to be irradiated R1. An area between the irradiation area AR1 and the irradiation area AR2 disposed at a predetermined interval, an area between the irradiation area AR2 and the irradiation area AR3 disposed at a predetermined interval, and an area between the irradiation area AR3 and the irradiation area AR4 disposed at a predetermined interval are set as intermittent areas ARs in which the laser irradiation is not performed.

The pulse laser beam PL1 output from the laser apparatus L1 is branched by the beam splitters BS1, BS2, BS3, BS4 to be incident on the respective irradiation areas AR1, AR2, AR3, AR4. The reflectance rate of each of the beam splitters BS1, BS2, BS3, BS4 is set such that the laser energy at each of the irradiation areas AR1, AR2, AR3, AR4 is equal. The beamsplitter BS4 in the final stage may be a reflective mirror.

In the laser annealing system 10B, the object to be irradiated R1 moves at a low speed. The moving speed of the object to be irradiated R1 is set such that the suspension period is the time it takes to pass through the intermittent area ARs. The number of times of irradiation per section is determined from the irradiation area width in the moving direction, the moving speed of the object to be irradiated R1, and the repetition frequency.

### 7.2 Operation

The laser apparatus L1 continuously outputs the pulse laser beam PL1 at a certain repetition frequency while the object to be irradiated R1 is being moved by the roll-to-roll method. A graph F19B in FIG. 19 shows the pulse energy of the pulse laser beam PL1 output from the laser apparatus L1.

An enlarged view F19C in FIG. 19 is an explanatory view showing a laser irradiation result when the irradiation area AR1 is continuously irradiated with the pulse laser beam. In the laser annealing system 10B, the position of the beam with which irradiation is performed is fixed in each of the irradiation areas AR1 to AR4, but the object to be irradiated R1 moves in the roll traveling direction (moving direction). Thus, the section that has been laser-irradiated moves relatively and the ranges of irradiation of the beams overlap each other (see the enlarged view F19C).

Therefore, the number of times of irradiation per section (the same section) is determined based on the beam width on the object to be irradiated R1 in the moving direction, the moving speed (roll traveling speed), and the repetition frequency of the pulse laser beam PL1. By setting the irradiation areas AR1, AR2, AR3, AR4 and setting the places between the irradiation areas AR1, AR2, AR3, AR4 as the intermittent areas, the respective areas on the object to be irradiated R1 are irradiated with the burst pulse similar to that of Embodiment 1.

A graph F19D in FIG. 19 shows an example of a burst pulse of the pulse laser beam with which the same section on the object to be irradiated R1 is irradiated.

By dividing the areas into the irradiation areas AR1, AR2, AR3, AR4 and the intermittent areas ARs therebetween, each section on the object to be irradiated R1 is placed in a state of being irradiated with a burst pulse as shown in the graph F19D by roll traveling. As a result, burst irradiation similar to that of the laser apparatus 12 in Embodiment 1 can be performed.

In the laser annealing system 10B, the annealing treatment may be performed in the middle of winding a resin substrate onto a roll after a thin film is formed on the resin substrate.

A part of each of the upstream side and the downstream side of the respective irradiation areas AR1, AR2, AR3, AR4 is irradiated by a smaller number of times, and hence does not necessarily need to be used as an element. Here, the “upstream side” means the upstream side with respect to the moving direction of the object to be irradiated R1 and refers to the left side in FIG. 19.

### 7.3 Example of Conveyance Mechanism

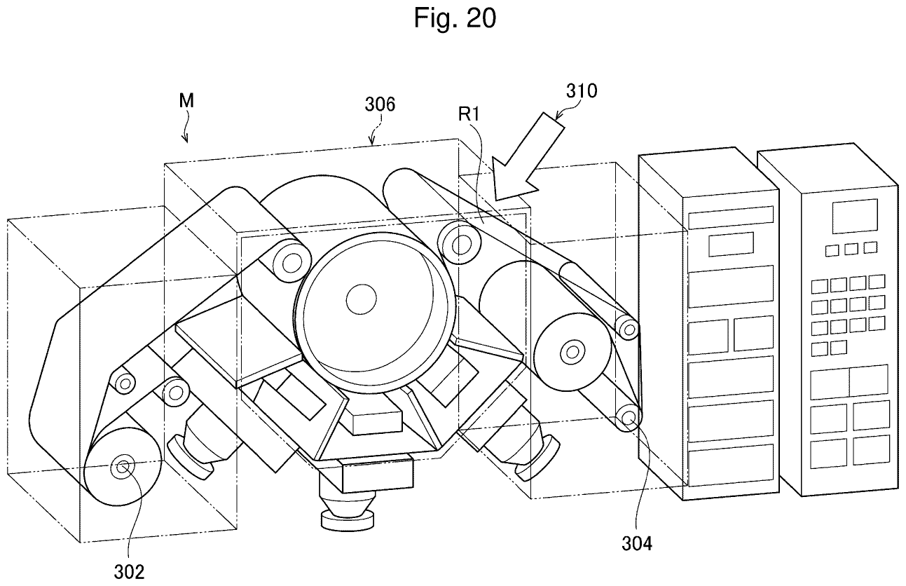

FIG. 20 is a perspective view showing an example of a roll-to-roll conveyance mechanism M applied to the laser annealing system 10B. The conveyance mechanism M includes an unwinding unit 302 and a winding unit 304, and a film forming unit 306 and a laser annealing treatment unit 310 are provided between the unwinding unit 302 and the winding unit 304. The film forming unit 306 is a processing unit of a film forming step of forming a thin film of ITO or the like on a substrate fed out from the unwinding unit 302. The laser annealing treatment unit 310 is disposed on the downstream side of the film forming unit 306 and is a processing unit of an annealing treatment step of performing laser irradiation in a portion indicated by an arrow in FIG. 20. Although the specific configuration of the laser annealing treatment unit 310 is not shown in FIG. 20, the laser annealing treatment unit 310 includes the irradiation areas AR1, AR2, AR3, AR4 described with reference to FIG. 19. The laser annealing treatment unit 310 includes a configuration of an optical system and the like necessary for laser irradiation.

With such a configuration, in a roll-to-roll step process, the annealing treatment can be performed in the middle of winding the roll after the thin film is formed.

The conveyance mechanism M may include a cooling roller (not shown) instead of the cooling plate 78 described with reference to FIGS. 7 and 8. The cooling roller may be disposed on the back side of the substrate in each of the irradiation areas AR1, AR2, AR3, AR4.

### 7.4 Effect

According to Embodiment 3, it is possible to perform the annealing treatment while winding the roll in the roll-to-roll method. Therefore, the processing time can be shortened as compared with the annealing treatment in which the winding is stopped.

### 7.5 Modification 1 of Embodiment 3

### 7.5.1 Configuration

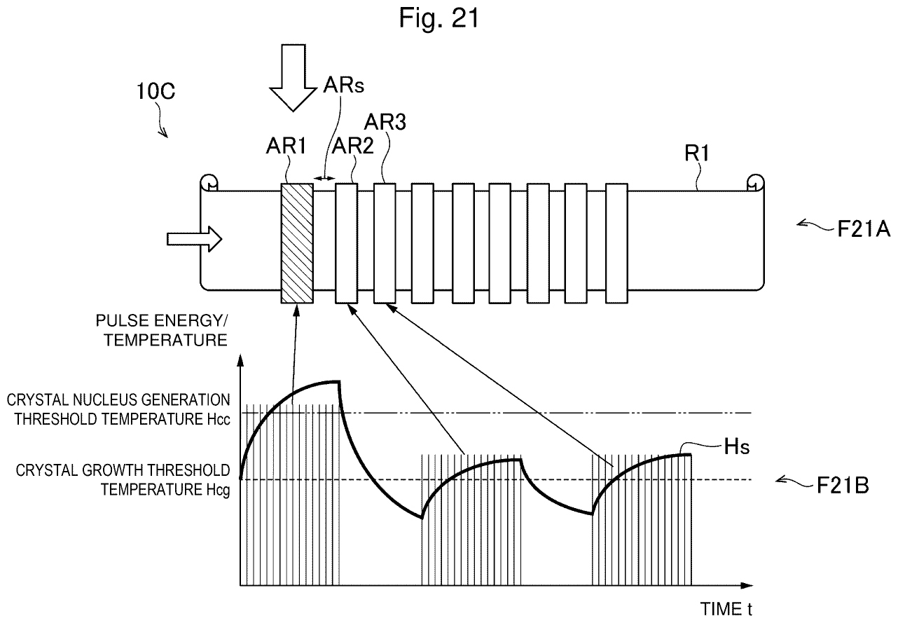

FIG. 21 is an explanatory diagram showing a configuration and an operation of a laser annealing system 10C according to Modification 1 of Embodiment 3. The configuration shown in FIG. 21 will be described with respect to features different from those of the configuration shown in FIG. 19. A schematic plan view F21A shown in the upper part of FIG. 21 shows an example of the irradiation areas AR1, AR2, AR3 . . . in the laser annealing system 10C. Although not shown in the drawing, the laser annealing system 10C includes the laser apparatus L1 and the beam splitters that cause the pulse laser beam to be incident on the respective irradiation areas AR1, AR2, AR3 . . . in the same manner as in FIG. 19.

In the laser annealing system 10C, an area to be irradiated with a burst pulse with a high energy or a high repetition frequency is disposed in an upstream part of the irradiation areas AR1, AR2, AR3 . . . when the two-stage growth is performed so as to correspond to Embodiment 2.

In FIG. 21, an example of a case in which the leading irradiation area AR1 is irradiated with a pulse laser beam having a pulse energy higher than that of the other irradiation areas is shown. In this case, the reflectance rate of a beam splitter on the upstream side may be set to be higher than the reflectance rate of other beam splitters such that a large amount of energy is distributed, for example.

A graph F21B shown in the lower part of FIG. 21 shows an example of burst irradiation by the laser annealing system 10C and an example of the change in the thin film surface temperature Hs in accordance with the burst irradiation. In FIG. 21, the burst periods corresponding to areas from the leading irradiation area AR1 to the third irradiation area AR3 are shown, but the same applies to burst periods corresponding to a fourth irradiation area and irradiation areas thereafter. The graph F21B is similar to the graph described with reference to FIG. 15.

### 7.5.2 Operation

The operation of the laser irradiation in the laser annealing system 10C is similar to that of Embodiment 3. By the burst irradiation by the laser annealing system 10C, the crystal is grown in two stages in a manner similar to that of Embodiment 2.

### 7.5.3 Effect

With the laser annealing system 10C, the crystal can be grown in two stages in a roll-to-roll process, and a highly mobile crystal can be obtained.

### 7.6 Modification 2 of Embodiment 3

### 7.6.1 Configuration

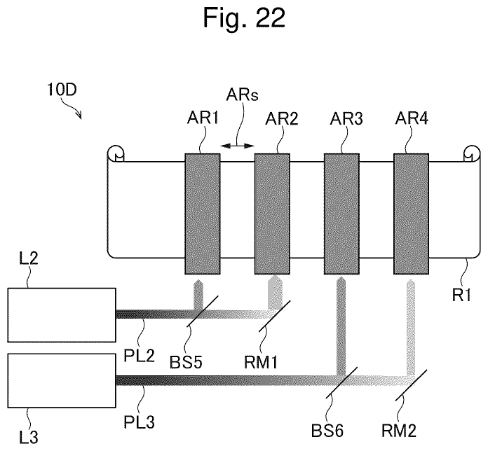

FIG. 22 schematically shows a configuration of a laser annealing system 10D according to Modification 2 of Embodiment 3. The configuration shown in FIG. 22 will be described with respect to features different from those of the configuration shown in FIG. 19.

The laser annealing system 10D includes a plurality of laser apparatus L2, L3 instead of the laser apparatus L1 of FIG. 19. The laser annealing system 10D also includes a beam splitter BS5, a reflective mirror RM1, a beam splitter BS6, and a reflective mirror RM3 instead of the beam splitter BS1 to BS4 of FIG. 19. Other configurations may be similar to those in FIG. 19.

A high pulse energy and a high repetition frequency may be required depending on the width of the rolls, the number of the irradiation areas, or the positions of the irradiation areas. In this case, as shown in FIG. 22, the laser apparatuses L2, L3 may be disposed so as to distribute pulse laser beams to the different irradiation areas AR1, AR2, AR3, AR4.

### 7.6.2 Operation

The laser apparatuses L2, L3 are controlled to output pulse laser beams PL2, PL3 in synchronism. The pulse laser beam PL2 output from the laser apparatus L2 is branched in two directions by the beam splitter BS5. Out of the branched pulse laser beams, one pulse laser beam is incident on the irradiation area AR1, and the other pulse laser beam is reflected by the reflective mirror RM1 and incident on the irradiation area AR2. For example, the irradiation area AR1 may be irradiated with a pulse laser beam having a higher pulse energy as compared to the irradiation area AR2. The laser apparatus L2 may set a high repetition frequency as compared to the laser apparatus L3.

Similarly, the pulse laser beam PL3 output from the laser apparatus L3 is branched in two directions by the beam splitter BS6. Out of the branched pulse laser beams, one pulse laser beam is incident on the irradiation area AR3, and the other pulse laser beam is reflected by the reflective mirror RM2 and incident on the irradiation area AR4. Other Operations are similar to those of FIG. 19.

### 7.6.3 Effect

With the laser annealing system 10D, an effect similar to that of the laser annealing system 10B can be obtained. With the laser annealing system 10D, it is possible to distribute pulse laser beams having a desired pulse energy to the respective irradiation areas. A plurality of laser apparatuses is provided, and hence it is possible to irradiate each irradiation area with a pulse laser beam having a desired repetition frequency.

### 8. Embodiment 4

### 8.1 Configuration

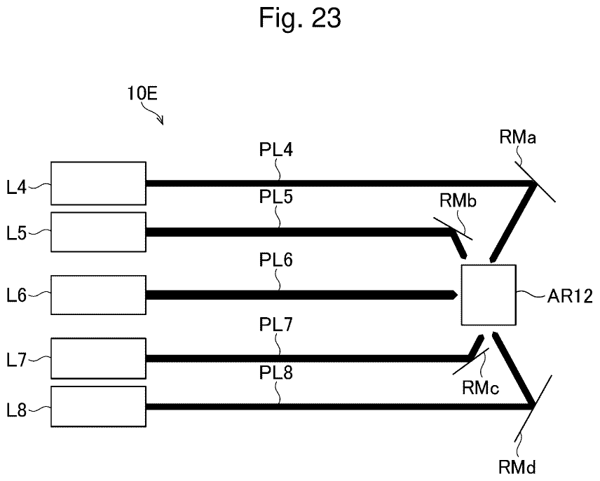

FIG. 23 schematically shows a configuration of a laser annealing system 10E according to Embodiment 4. The laser annealing system 10E includes a plurality of laser apparatuses L4, L5, L6, L7, L8 instead of the laser apparatus 12. Each of the laser apparatuses L4, L5, L6, L7, L8 may have a configuration similar to that of the laser apparatus 12.

The laser annealing system 10E includes reflective mirrors RMa, RMb, RMc, RMd that guide pulse laser beams PL4, PL5, PL6, PL7, PL8 output from the laser apparatuses L4, L5, L6, L7, L8 to an irradiation area AR12. The pulse laser beam paths that guide the pulse laser beams PL4, PL5, PL6, PL7, PL8 to the irradiation area AR12 may include optical elements such as a reflective mirror (not shown) other than the reflective mirrors RMa, RMb, RMC, RMd.

The irradiation area AR12 may be an area on the table 76 described with reference to FIG. 2 or may be the irradiation areas AR1, AR2, AR3, AR4 described with reference to FIG. 19.

Although FIG. 23 shows a configuration in which five laser apparatuses L4 to L8 are used, the number of laser apparatuses is not limited to this example.

### 8.2 Operation

High repetitive irradiation in the irradiation area AR12 may be realized by performing control of delaying output timings of the pulse laser beams from the laser apparatuses L4 to L8.

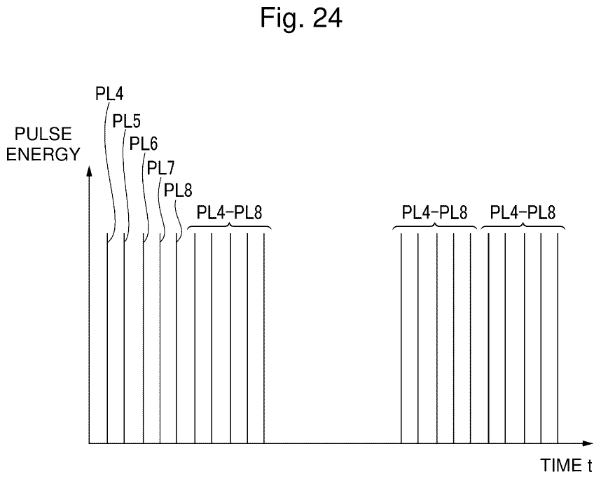

FIG. 24 is a graph showing an example of burst irradiation implemented by the laser annealing system 10E. As shown in FIG. 24, it is possible to perform burst irradiation substantially similar to the burst operation with high repetition by shifting the respective output timings of the pulse laser beams PL4 to PL8 output from the laser apparatuses L4 to L8 and irradiating the same irradiation area AR1.

For example, when an operation in which the repetition frequency of the laser apparatuses L4 to L8 is 200 Hz is performed, pseudo 1 kHz irradiation can be realized by irradiating the same area while displacing the output timings of the five laser apparatuses L4 to L8.

### 8.3 Effect

With the laser annealing system 10E according to Embodiment 4, it is possible to realize burst irradiation with a repetition frequency higher than the repetition frequency of the individual laser apparatuses L4 to L8.

### 9. Applications Other than ITO Thin Film

The technology of the present disclosure is also applicable to the following applications.
[1] Annealing treatment for crystallization of a channel material such as a-Si
[2] Annealing treatment (treatment of magnetic material formation) for alloying metal materials after depositing a plurality of metal films on a substrate with poor heat resistance such as a resin film
[3] Annealing treatment for crystal recovery after ion implantation in a semiconductor process
[4] Control of thermal diffusion of a dopant material in the substrate depth direction
[5] Annealing treatment when heat treatment of a coating material such as a hard coating film with respect to a film and the like is performed
[6] Annealing treatment for reducing resistance by crystal grain enlargement in metal wiring on a semiconductor chip or a printed circuit board

### 10. Processor

A processor such as the laser control processor 28 and the laser annealing control processor 100 may be physically configured as hardware to execute the various processes included in the present disclosure. For example, the processor may be a computer including a memory that stores a control program defining the various processes and a processing device that executes the control program. The control program may be stored in one memory, or may be stored separately in a plurality of memories at physically separate locations, and the various processes included in the present disclosure may be defined by a combination of control programs stored in the memories. The processing device may be a general-purpose processing device such as a CPU or a special-purpose processing device such as a GPU.

Alternatively, the processor may be programmed as software to execute the various processes included in the present disclosure. For example, the processor may be implemented in a dedicated device such as an ASIC or a programmable device such as a FPGA.

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 11. Other

The description above is intended to be illustrative and the present disclosure is not limited thereto. Therefore, it is obvious to those skilled in the art that various modifications to the embodiments of the present disclosure would be possible without departing from the spirit and the scope of the claims. Further, it is also obvious for those skilled in the art that embodiments of the present disclosure would be appropriately combined.

The terms used throughout the present specification and the claims should be interpreted as non-limiting terms unless clearly described. For example, terms such as “include”, “have”, “comprise”, “contain” and the like should not be interpreted to be exclusive of other structural elements. Further, indefinite articles “a/an” should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser annealing system for annealing a thin film on a substrate by irradiating the thin film with a pulse laser beam, the laser annealing system comprising:
a laser apparatus configured to output the pulse laser beam;
an optical system configured to irradiate the thin film with the pulse laser beam; and
a processor configured to perform control of irradiating a same section of the thin film with the pulse laser beam by performing burst irradiation that alternates between a burst period of continuously performing irradiation with the pulse laser beam and a suppression period of suppressing the irradiation with the pulse laser beam.

2. The laser annealing system according to claim 1, wherein
a fluence of the pulse laser beam with which the thin film is irradiated is less than an ablation threshold of the thin film.

3. The laser annealing system according to claim 1, wherein
the processor controls a fluence of the pulse laser beam with which the thin film is irradiated such that the fluence is less than an ablation threshold of the thin film.

4. The laser annealing system according to claim 1, wherein
an irradiation condition of the burst irradiation is set such that a surface temperature of the thin film exceeds a crystallization threshold temperature of the thin film during the burst period and a temperature of an interface between the thin film and the substrate is maintained below a damage threshold temperature of the substrate during the burst period and the suppression period.

5. The laser annealing system according to claim 4, wherein
the irradiation condition includes at least one parameter out of a pulse energy, a repetition frequency, or a number of pulses of the pulse laser beam in the burst period, a length of the suppression period, or a number of bursts.

6. The laser annealing system according to claim 1, wherein
the processor controls an operation of the burst irradiation such that a surface temperature of the thin film exceeds a crystallization threshold temperature of the thin film during the burst period and a temperature of an interface between the thin film and the substrate is maintained below a damage threshold temperature of the substrate during the burst period and the suppression period.

7. The laser annealing system according to claim 1, further comprising a cooling mechanism configured to cool the substrate.

8. The laser annealing system according to claim 1, wherein
irradiation with the pulse laser beam in a leading burst period out of a plurality of the burst periods is performed at a higher pulse energy, a higher repetition frequency, or a larger number of pulses than the pulse laser beam in the other burst period.

9. The laser annealing system according to claim 8, wherein
a suppression period immediately after the leading burst period out of a plurality of the suppression periods is longer than the other suppression period.

10. The laser annealing system according to claim 8, wherein
an irradiation condition of the burst irradiation is set such that a surface temperature of the thin film exceeds a crystal nucleus generation threshold temperature of the thin film during the leading burst period, the surface temperature of the thin film is maintained below the crystal nucleus generation threshold temperature during the other burst period, and the surface temperature of the thin film exceeds a crystal growth threshold temperature of the thin film during the other burst period.

11. The laser annealing system according to claim 8, wherein
the processor controls operation of the burst irradiation such that a surface temperature of the thin film exceeds a crystal nucleus generation threshold temperature of the thin film during the leading burst period, the surface temperature of the thin film is maintained below the crystal nucleus generation threshold temperature during the other burst period, and the surface temperature of the thin film exceeds a crystal growth threshold temperature of the thin film during the other burst period.

12. The laser annealing system according to claim 1, wherein
the suppression period is a suspension period of stopping the irradiation with the pulse laser beam or a low output period of performing irradiation with the pulse laser beam at a lower pulse energy than the pulse laser beam in the burst period.

13. The laser annealing system according to claim 1, further comprising a conveyance mechanism configured to convey the substrate by a roll-to-roll method, wherein
an object to be irradiated in which the thin film has been formed is subjected to the burst irradiation while the substrate is moved by the conveyance mechanism.

14. The laser annealing system according to claim 13, wherein
a plurality of irradiation areas at which the object to be irradiated is irradiated with the pulse laser beam is disposed at a predetermined interval along a moving direction of the object to be irradiated.

15. The laser annealing system according to claim 14, wherein
the processor controls a number of times of irradiation per the same section based on a moving speed of the object to be irradiated, a width of the irradiation area, and a repetition frequency of the pulse laser beam.

16. The laser annealing system according to claim 14, further comprising a beam splitter configured to distribute the pulse laser beam output from the laser apparatus to the irradiation areas.

17. The laser annealing system according to claim 14, wherein
the processor adjusts an irradiation condition such that a surface temperature of the thin film becomes equal to or higher than a crystal nucleus generation threshold temperature by irradiation with the pulse laser beam in an irradiation area on an upstream side out of the irradiation areas.

18. The laser annealing system according to claim 17, wherein
the processor adjusts the irradiation condition such that a state in which the surface temperature of the thin film is equal to or higher than a crystal growth threshold temperature and is below the crystal nucleus generation threshold temperature is maintained by irradiation with the pulse laser beam in an irradiation area other than the irradiation area on the upstream side.

19. The laser annealing system according to claim 1, wherein
the laser annealing system includes a plurality of the laser apparatuses, and
the processor performs control of delaying an output timing of each pulse laser beam from the laser apparatuses.

20. A laser annealing method of annealing a thin film on a substrate by irradiating the thin film with a pulse laser beam, the laser annealing method comprising:
outputting the pulse laser beam from a laser apparatus;
irradiating the thin film with the pulse laser beam by an optical system; and
irradiating a same section of the thin film with the pulse laser beam by performing burst irradiation that alternates between a burst period of continuously performing irradiation with the pulse laser beam and a suppression period of suppressing the irradiation with the pulse laser beam.
